(19) United States
(12) Patent Application Publication
(10) Pub. No.: US 2005/0231635 A1
(43) Pub. Date: Oct. 20, 2005

(54) Automated inverse telecine process

(76) Inventor: Ken K. Lin, Redwood City, CA (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/826,784

(22) Filed: Apr. 16, 2004

(51) Int. Cl. H04N 11/20

(52) U.S. Cl. 348/441

(57) ABSTRACT

Disclosed herein is a method to detect and identify 3-2 pulldown patterns in a video sequence. If no 3-2 pulldown pattern is detected, the video remains unmodified. If 3-2 pulldown patterns are found, repeated fields are removed and original frames are reconstructed. Optionally, additional instructions may be generated for a video encoder. Additionally, in accordance with the present invention, repeated fields are removed in a way that does not throw away any information. The method described herein describes a plurality of operations that define one or more metrics or parameters of the video data for use in identifying the repeated fields.

### BACKGROUND

The present invention is in the field of video processing. More specifically, the invention provides a method to detect and identify the 3-2 pulldown patterns in a video sequence resulting from a film to NTSC conversion. It automatically reconstructs the original frames and sets the flags for MPEG encoding purposes.

Motion picture photography has a rate of 24 frames per second. Every frame itself is a complete picture, also known as a “progressive frame. ” This means that all fields, top and bottom, correspond to the same instant of time.

Video signals, on the other hand, have an interlaced structure. A video frame is divided into top and bottom fields, and scanning of one field does not start until the other one is finished. Moreover, video signals have a different frame rate. The NTSC standard (used primarily in North America) uses a frame rate of approximately thirty frames per second. The PAL standard (used in most of the rest of the world) uses a frame rate of twenty-five frames per second.

The different frame rates used by film and video complicate the conversion between the two formats. For film to NTSC video conversion, ten video fields need to be generated for every four film frames. This telecine process is often accomplished by generating two fields from one progressive frame, three fields from the next film frame, and repeating the 3-2 pattern for the rest of the sequence. Because of the 3-2 pattern, the process is often called 3-2 pulldown. This pattern is illustrated generally in FIG. 1.

The added (duplicate) fields in the telecine process enable the viewing of film materials in the video format. However, in some applications, it is desirable to remove the duplicate fields. For example, the repeated fields do not contain new information and should be removed before encoding (compression). Also, the telecine process creates video frames that have jagged vertical edges, which are not aesthetically pleasing when viewed on a progressive display.

An inverse telecine process converts a video signal (interlaced) back to a film (progressive) format. It takes incoming field image data, which is presumed to have been generated from film source material, and outputs the original frame images. The problem looks easy, but is actually quite complicated for several reasons. First, there may be noise in the video data. The noise in the video may be the result of processing in the video domain, resulting in random noise, or may be the result of compression, resulting in compression noise being added to the material. In any case, the repeated fields may not be identical, and one cannot rely solely on the similarity between two fields to determine the 3-2 pulldown pattern.

A second complication arises if editing has been performed in the video domain. For example, a cut in the video domain may disrupt the 3-2 pulldown pattern or even leave some fields with no corresponding opposite field in the original motion picture. Operations such as fading, adding text, or picture-in-picture may also complicate detection and recognition of the 3-2 pulldown pattern. Furthermore, some video programs may have sections of film interspersed with materials shot with a typical video camera (e.g., an NTSC video camera) where no 3-2 pulldown pattern exists. These all make an inverse telecine a much more difficult problem than forward 3-2 pulldown.

Thus, it would be beneficial to provide an automated inverse telecine process that can robustly identify the duplicate fields.

### SUMMARY

The present invention relates to a method to detect and identify 3-2 pulldown patterns in a video sequence. If no 3-2 pulldown pattern is detected, the video remains unmodified. If 3-2 pulldown patterns are found, repeated fields are removed and original frames are reconstructed. Optionally, additional instructions may be generated for a video encoder. Additionally, in accordance with the present invention, repeated fields are removed in a way that does not throw away any information. The method described herein describes a plurality of operations that define one or more metrics or parameters of the video data for use in identifying the repeated fields.

### BRIEF DESCRIPTION OF THE DRAWINGS

FIG. 1 diagrammatically illustrates a forward telecine, or 3-2 pulldown process, for a sequence of frames.

FIG. 2 illustrates generally a flowchart for an inverse telecine process according to the present invention.

FIG. 3 illustrates five possible scenarios for the arrangement of a 3-2-3 pulldown pattern within a sequence of frames.

FIG. 4 illustrates the arrangement of a repeating 3-2-3 pulldown pattern and the double triangle structure used to identify the 3-2-3 pulldown pattern.

FIG. 5 illustrates two 3-2-3 pulldown patterns one beginning at position o in the frame buffer and one beginning at position 4.

FIG. 6 illustrates a table of flag values for particular frames, which are set by the inverse telecine process in accordance with the use of an MPEG-2 encoder.

### DETAILED DESCRIPTION

An automated inverse telecine process is described herein. The following embodiments of the invention, described in terms of applications compatible with computer systems manufactured by Apple Computer, Inc. of Cupertino, California, are illustrative only and should not be considered limiting in any respect. As used herein, the terms “frame”, “picture”, and “image” are generally synonymous and should be construed as such unless context dictates otherwise. Likewise, film format refers generally to any progressive format and video refers to an interlaced format unless the context indicates otherwise.

This invention provides a method to detect and identify 3-2 pulldown patterns in a video sequence. If no 3-2 pulldown pattern is detected, the video remains unmodified. If 3-2 pulldown patterns are found, repeated fields are removed and original frames are reconstructed. Additionally, instructions are generated for an MPEG-2 encoder so that three flags—picture₁₃ structure, progressive₁₃ frame, and repeat₁₃ first₁₃ field—can be set correctly. Alternative video codecs may also be used, in which case appropriate flags would be set. Additionally, in accordance with the present invention, repeated fields are removed in a way that does not throw away any information.

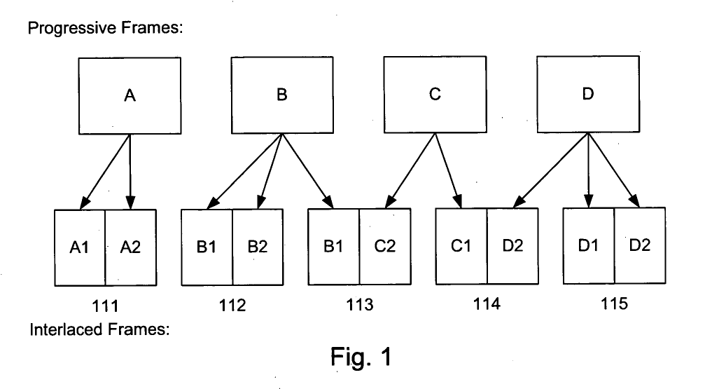

Consider the four pictures 112, 113, 114, and 115 generated by frames B, C, and D in FIG. 1. These four pictures constitute a 3-2-3 pattern because they have three fields from frame B, two from frame C, and three from frame D. If an incomplete 3-2-3 pattern exists in the beginning or at the end of a segment (for example, due to an edit operation), the repeated field is not removed and the pictures that have top and bottom fields from different original film frames are marked non-progressive.

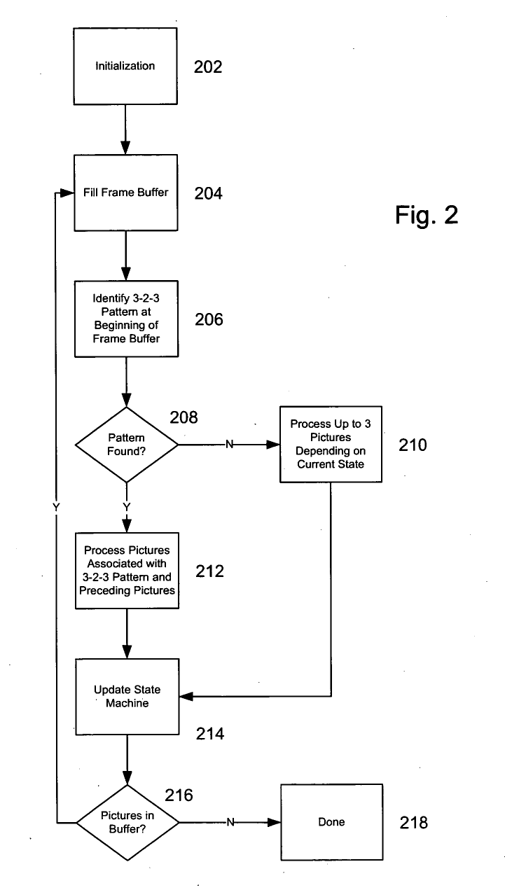

FIG. 2 shows a block diagram of the inverse telecine algorithm. In the beginning of every iteration, the frame buffer is filled in step 204. In step 206, the pictures in the buffer are analyzed to determine if there is a 3-2-3 pattern among the first eight pictures. If a 3-2-3 pattern is identified, all pictures up to and including those associated with the 3-2-3 pattern are processed to generate output frames (step 212). The four pictures associated with the 3-2-3 pattern are processed to reconstruct progressive frames.

Pictures at the beginning of the buffer that are not part of the 3-2-3 pattern are reproduced at the output unmodified, and may be classified as non-progressive as they may be part of another video segment. If a 3-2-3 pattern is not identified, up to three pictures will be processed (step 210) depending on the result of the previous iteration. In this case, all processed pictures are reproduced at the output unmodified. They can be marked either progressive or non-progressive as determined from the analysis of their content.

Finally, a finite state machine is updated in step 214 according to the results of the current iteration. In step 216, the frame buffer is checked. If there are pictures remaining in the buffer, the process returns to step 204 for the next iteration; otherwise, go to step 218 and the process is finished.

The finite state machine uses four states to keep track of the long-term trend of the input video, which are defined as follows:
State 0: Initialization. The state of the machine is set to 0 during initialization.
State 1: No 3-2-3 pattern found. If no 3-2-3 pattern is identified among the first eight pictures in the buffer during the current iteration, and the condition for entering state 2 is not true, the finite state machine enters state 1 at the end of the iteration.

State 2: End of a 3-2 pulldown pattern. If (a) no 3-2-3 pattern is identified among the first eight pictures in the frame buffer, (b) the current state (set at the end of the previous iteration) is 3, (c) the first two pictures in the frame buffer are classified as progressive, and (d) these two pictures have been determined to be associated with the last picture processed in the previous iteration; then the finite state machine enters state 2 at the end of the iteration.

State 3: Pattern found. If a 3-2-3 pattern is identified among the first eight pictures in the frame buffer, the finite state machine enters state 3 at the end of the iteration.

Following below is a more detailed description of the process depicted in FIG. 2. In step 204, pictures are read from the video source to the frame buffer. The buffer size should be at least twelve frames. After pictures are processed in step 210 and 212, they are removed from the frame buffer, and remaining pictures in the buffer are moved to the front. At most eight pictures can be processed in one iteration, so there are always pictures in the buffer in step 216 before the input video is run out.

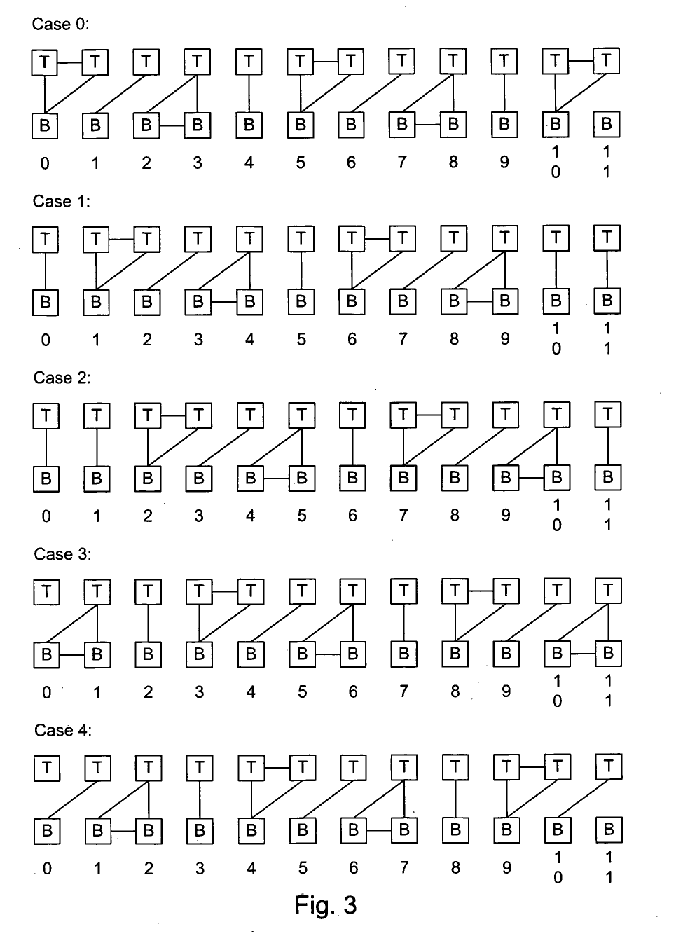

In step 206, 3-2-3 patterns are identified among the first eight pictures in the frame buffer. Assuming no prior edits, there are five possible starting positions for 3-2 pulldown patterns. These five positions are illustrated in FIG. 3 for a top field first sequence.

The lines connecting two fields of the same parity in two different frames indicate duplicate fields. The lines connecting a top field and a bottom field indicate that the two fields came from the same frame in the original film. A triangle is formed in the pattern diagram if a field is repeated. When the repeated field is the first field in the video, the triangle has a vertical left edge, and is referred to as a “left triangle. ” In FIG. 3, the top field is the first field, so the triangle formed by T₀, T₁, and B₀ in Case 0 is a left triangle. Similarly, when the repeated field is not the first field, the triangle has a vertical right edge and is referred to as a “right triangle, ” for example, the triangle formed by B₂, B₃, and T₃ in Case 0.

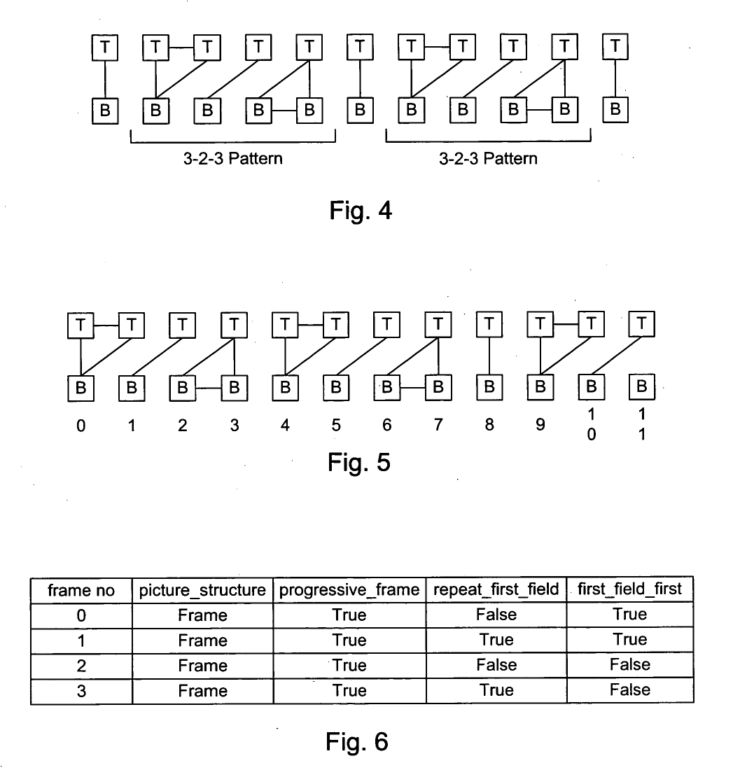

A double triangle structure is a left triangle followed by two fields from the same film frame but in different video pictures (after 3-2 pulldown) followed by a right triangle. This is illustrated in FIG. 4. A double triangle structure is also referred to as a 3-2-3 pattern because it comprises three fields from a film frame, two fields from the next film frame, and three fields from the third film frame.

Because the repeated field in a single triangle (not in a double triangle structure) cannot be properly removed, there is no need to identify a single triangle repeated field. Therefore, the objective in step 206 (FIG. 2) is to identify a double triangle structure, or a 3-2-3 pattern, in the first eight pictures in the frame buffer. The algorithm to identify a double triangle structure can be made more robust against noise compared with those for single triangles.

Identifying a 3-2-3 pattern in step 206 (FIG. 2) is a two-step process. The first step is to identify the position where a 3-2-3 pattern is most likely to be found. A 3-2-3 pattern is said to be at position i when the left edge of its left triangle corresponds to picture i. The second step is to determine whether the 3-2-3 pattern is legitimate or a false alarm.

The process requires two measurements, “field identity” and “frame correlation. ” Field identity measures the similarity between two fields of the same parity (i.e., two top fields or two bottom fields) to help identify repeated fields. Field identity should be 0 when the two fields are identical, and positive when they are not. Field identity may be determined from a variety of distortion measures, for example, sum of absolute difference or mean squared error. However, any measure that is small if the two fields are similar and is large of two fields are not similar can be used as a field identity. Frame correlation measures how closely two opposite fields are related to each other. If the two fields come from one progressive frame, their frame correlation should be small. One example of such a measure would be the sum of absolute difference between one input field and an interpolated field of the other input field of a different parity.

To locate a 3-2-3 pattern, six parameters are calculated for each position in the frame buffer. The six parameters are computed using the two measures defined above. The first two parameters are related to the field identity measure. “First field identity” measures the field identity between a first field of a picture and the first field of the subsequent picture, i.e., the first fields of picture i and picture i+1. Similarly, “second field identity” measures the field identity between the second fields of picture i and picture i+1.

The next three parameters are related to the frame correlation measure. The third parameter is “self frame correlation, ” which is the frame correlation measure between the top and bottom fields of the same picture. “Cross frame correlation” is also calculated, which is the frame correlation between a second field of the frame and the first field of the next frame, i.e., the frame correlation between the second field of picture i and the first field of picture i+1. The fifth parameter is “inverse cross frame correlation, ” which is the frame correlation measure between the first field of the corresponding frame and the second field of the following frame.

Finally, from these parameters a “new scene score” is calculated. The new scene score is the ratio of cross frame correlation for the previous frame to the greater of cross frame correlation of the second previous frame or cross frame correlation of the current frame. A large value of the new scene score indicates that the corresponding picture is likely to be the first picture in a new scene.

From these six parameters, i.e., “first field identity, ” “second field identity, ” “self frame correlation, ” “cross frame correlation, ” “inverse cross frame correlation, ” and “new scene score, ” six additional metrics are calculated. The additional metrics are “first field identity ratio, ” “second field identity ratio, ” “left triangle score, ” “right triangle score, ” “cross frame correlation score, ” and “double triangle score. ” These six metrics are used to locate the 3-2-3 pattern.

The “first field identity ratio” metric for a frame is defined as the ratio of the first field identity for the current frame to the smaller of the first field identity of the preceding or following frame. Similarly, the “second field identity ratio” is the ratio of the second field identity for the current frame to the smaller of the second field identity of the preceding or following frame. The “left triangle score” for a frame is two times the first field identity ratio for a frame plus the ratio of self frame correlation for the frame to the self frame correlation for the subsequent frame. A small value of left triangle score indicates that a left triangle likely exists between the current picture and the subsequent picture. Similarly, the right triangle score is two times the second field identity ratio for a frame plus the ratio of self frame correlation of the of the subsequent frame to the self frame correlation of the current frame. A small value of right triangle score indicates that a right triangle likely exists between the current picture and the subsequent picture.

The fifth metric is “cross frame correlation score, ” which is defined as the ratio of cross frame correlation for the current picture to cross frame correlation of the next or previous frame, whichever is smaller. A large value of cross frame correlation score indicates that there is a cut between the current picture and the next picture.

The sixth metric is the “double triangle score, ” which is the sum of the left triangle score of the current frame, the cross frame correlation score of the subsequent frame and the right triangle score of the second subsequent frame. A small value of the double triangle score indicates that a 3-2-3 pattern exists between picture i and picture i+3. The double triangle score is computed for each of the first five frames in the buffer. The frame that yields the smallest value of double triangle score is the most likely to be a legitimate 3-2-3 pattern.

To verify the legitimacy of this 3-2-3 sequence, six additional metrics are calculated, “frame correlation change, ” “frame correlation ratio, ” “cross frame correlation ratio, ” “inverse cross frame correlation ratio, ” “first field identity ratio 2, ” and “second field identity ratio 2. ”

The “frame correlation change” is determined by rearranging the four pictures in the video domain to three frames in the film domain by removing the repeated fields. The ratio of the average self frame correlation in the film domain to the average self frame correlation in the video domain is then the frame correlation change. If the four pictures were indeed generated by a 3-2 pulldown, the frame correlation change should be smaller than 1.

To determine the “frame correlation ratio, ” suppose the 3-2-3 pattern is at position i in the frame buffer. The frame correlation ratio for this 3-2-3 pattern is the average of (1) the ratio of self frame correlation of the current frame (self₁₃ frame₁₃ correlation[i]) to the self frame correlation of the subsequent frame (self₁₃ frame₁₃ correlation[i+1]) and (2) the ratio of the self frame correlation of the third subsequent frame (self₁₃ frame₁₃ correlation[i+3]) to the self frame correlation of the second subsequent frame (self₁₃ frame₁₃ correlation[i+2]). If the four pictures have indeed been generated from a film source via 3-2 pulldown, the frame correlation ratio should be smaller than 1.

Likewise, the “cross frame correlation ratio” for a 3-2-3 pattern at position i in the frame buffer is the average of (1) the cross frame correlation for the i^{th} frame (cross¹³ frame₁₃ correlation[i]) and (2) the cross frame correlation for the second subsequent frame (cross₁₃ frame₁₃ correlation[i+2]), the average divided by the cross frame correlation of the subsequent frame (cross₁₃ frame₁₃ correlation[i+1]). If the four pictures have indeed been generated from a film source via 3-2 pulldown and have been compressed in the video domain, the cross frame correlation ratio should be smaller than 1.

The fourth metric is “inverse cross frame correlation ratio. ” For a 3-2-3pattern at position i in the frame buffer, the inverse cross frame correlation ratio is the ratio of the sum of cross frame correlation for the current frame, the subsequent frame, and the second subsequent frame to the sum of inverse cross frame correlation for the current frame, the subsequent frame, and the second subsequent frame. If the four pictures have indeed been generated from a film source via 3-2 pulldown, the inverse cross frame correlation ratio should be smaller than 1.

The fifth metric is “first field identity ratio 2. ” Suppose the 3-2-3 pattern is at position i in the frame buffer. “First field identity ratio 2” for this 3-2-3 pattern equals the ratio of first field identity for the current picture to the first field identity for the subsequent picture or the second subsequent picture, whichever is smaller.

Similarly, the sixth metric, “second field identity ratio 2, ” for a 3-2-3pattern located at position i in the frame buffer equals the ratio of second field identity for the second subsequent frame to the second field identity of the subsequent frame or the current frame, whichever is smaller.

All six metrics are nonnegative. For a sequence of identical pictures, the first four parameters all equal 1.000 while the last two are not defined. These six metrics are used to determine if the four pictures associated with the 3-2-3 pattern are indeed from a film source. For all six metrics, a small value indicates that the 3-2-3pattern is likely to be legitimate. The six metrics define a 6-D space, and the region of legitimacy is a region in this 6-D space in which the 3-2-3 pattern will be classified as being from a film source in the second step of 206.

The region can be found through training using sequences with known 3-2-3 patterns. For example, one can define a threshold for each of the six metrics and define the region of legitimacy as the six-dimensional “cube” in which all six metrics are smaller than their respective thresholds. The thresholds can be determined through training. Alternatively, a more general method is to define a few functions, every one of them a function of a subset of the six metrics. The region of legitimacy is then the region where the evaluated function values satisfy some predetermined requirements.

A few additional steps can be added to enhance the algorithm's robustness against noise. First, when the 3-2-3 pattern is found to be at position i, the last three pictures in the pattern—i+1, i+2, i+3—cannot be the start of a new scene. This can be checked by comparing their new scene scores with a predetermined threshold, for example, a cutoff derived from training. Second, when the 3-2-3 pattern is found to be at position 4, and the second lowest score occurs at position 0, it is possible that both are legitimate. This scenario is shown in FIG. 5. In this case, position 0 should be checked first. If it is legitimate, process this sequence and leave the 3-2-3pattern at position 4 to the next iteration; if not, check position 4.

If no legitimate 3-2-3 pattern is found, up to three pictures are processed, depending on the content of those pictures and the current state. This is done in step 210. If a legitimate 3-2-3 pattern is found, all pictures in the beginning of the buffer up to and including those associated with the 3-2-3 pattern are processed. This is done in step 212.

In step 210, if the current state is 0, 1, or 2, three pictures are processed. They are classified as non-progressive and are passed to the output unmodified. The state will be changed to 1 in step 214 for this case. If the current state is 3, which means a 3-2-3 pattern had been processed in the previous iteration, up to two pictures are processed. First, the new scene scores of pictures 0 and 1 are checked to see if they are progressive by comparing their self frame correlation values with a running average obtained from the pictures in all previously identified 3-2-3 patterns. If the self frame correlation value is smaller than the running average, the picture is classified as progressive; otherwise, it is classified as non-progressive. If two pictures are processed and they are both classified as progressive, the state will be changed to 2 in step 214; otherwise, the state will be changed to 1.

In step 212, pictures are processed according to the current state and the position of the identified 3-2-3 pattern. There are three possible cases. In all three cases, the state will be changed to 3 at step 214.

CASE 1: The current state of the state machine is 0, 1, or 2. When the current state is 0, picture 0 must be the start of a new scene. When the current state is 1, there may or may not be a new scene in the buffer as a new scene may have already been processed in the previous iteration. When the current state is 2, one of the pictures in the beginning of the buffer starting at position 0 up to and including the first picture in the 3-2-3 pattern must be the start of a new scene. The new scene can be identified by finding the picture with the largest new scene score, and in the case of state 1, comparing that with a predetermined threshold. Once the position of the new scene is identified, pictures before that position are associated with the pictures processed in the previous iteration, and pictures after that position are assumed to be in the same scene as the 3-2-3 pattern. These pictures, not including those in the 3-2-3 pattern, are reproduced at the output unmodified. They are classified as either progressive or non-progressive as determined by their self frame correlation measure in a manner consistent with the position of the new scene and the 3-2-3 pattern. The four pictures in the 3-2-3 pattern are processed in the same way as those in CASE 3.

CASE 2: The current state is 3 but the position of the 3-2-3 pattern is not 1. An edit point must exist among the pictures before the 3-2-3 pattern including the first picture in the 3-2-3 pattern. All pictures not in the 3-2-3 pattern are passed to the output unmodified. They are classified as either progressive or non-progressive as determined by their self frame correlation measure in a manner consistent with the position of the new scene and the 3-2-3 pattern. The four pictures in the 3-2-3 pattern are processed in the same way as those in CASE 3.

CASE 3: The current state is 3 and the position of the 3-2-3 pattern is 1. This is likely to be in the middle of a long 3-2 pulldown segment. Five pictures are processed to generate four frames. Frame 0 is a copy of picture 0. Frame 1 is a copy of picture 1. The first field of picture 2 and the second field of picture 3 are removed. The second field of picture 2 and the first field of picture 3 are combined to form frame 2. Finally, frame 3 is a copy of picture 3. The MPEG flags for the four output frames are listed in FIG. 6.

At the end of step 210 and 212, all processed pictures are removed from the frame buffer. Pictures that are not processed in this iteration are shifted to the front. In step 214, the finite state machine is updated according to the results in step 210 and 212 as described above. In step 216, if there are pictures in the buffer, go back to step 204 for the next iteration. If there are no pictures in the buffer, go to 218 and we are finished.

While the invention has been disclosed with respect to a limited number of embodiments, numerous modifications and variations will be appreciated by those skilled in the art. It is intended that all such variations and modifications fall with in the scope of the following claims.

1. A method of processing video data comprising:
receiving a sequence of video frames in an interlaced format;
detecting a 3-2 pulldown pattern; and
removing duplicate fields from the sequence of video frames.

2. The method of claim 1 further comprising:
passing instructions to a video encoder relating to the removed fields.

3. The method of claim 2 wherein the instructions relate to one or more flags in an MPEG-2 encoder.

4. The method of claim 3 wherein the one or more flags are selected from the group consisting of: picture₁₃ structure, progressive₁₃ frame, and repeat₁₃ first₁₃ field.

5. The method of claim 1 further comprising:
detecting a disrupted 3-2 pulldown pattern at an end of the sequence of video frames; and
leaving a duplicate field that is part of the disrupted 3-2 pulldown pattern.

6. The method of claim 5 further comprising marking frames left with a duplicate field as non-progressive.

7. The method of claim 1 wherein the step of detecting a 3-2 pulldown pattern comprises:
identifying a position within a buffer where the 3-2 pulldown pattern is likely to be found; and
determining whether a pattern located at the identified position is a legitimate 3-2 pulldown pattern.

8. The method of claim 7 wherein the step of identifying a position within a buffer comprises calculation of at least one field identity and at least one frame correlation.

9. The method of claim 8 wherein the at least one field identity is calculated as a sum of absolute difference between two fields from different frames having a common parity.

10. The method of claim 8 wherein the at least one field identity is calculated as a mean squared error between two fields from different frames having a common parity.

11. The method of claim 8 wherein the at least one frame correlation is calculated as a sum of absolute difference between an input field and an interpolated field of another input field having a different parity.

12. The method of claim 8 wherein the at least one frame correlation is calculated as a sum of squared error between an input field and an interpolated field of another input field having a different parity.

13. The method of claim 7 wherein the step of identifying a position within a buffer comprises calculation of one or more parameters selected from the group consisting of: first field identity, second field identity, self frame correlation, cross frame correlation, inverse cross frame correlation, and new scene score.

14. The method of claim 8 wherein the step of identifying a position within a buffer further comprises computing a plurality of metrics from the at least one field identity and at least one frame correlation.

15. The method of claim 14 wherein at least one of the plurality of metrics are selected from the group consisting of: first field identity ratio, second field identity ratio, left triangle score, right triangle score, cross frame correlation score, and double triangle score.

16. The method of claim 7 wherein the step of determining whether a pattern located at the identified position is a legitimate 3-2 pulldown pattern further comprises computing at least one metric selected from the group consisting of: frame correlation change, frame correlation ratio, cross frame correlation ratio, inverse cross frame correlation ratio, first field identity ratio 2, and second field identity ratio 2.

17. The method of claim 16 wherein the step of determining whether a pattern located at the identified position is a legitimate 3-2 pulldown pattern comprises analyzing the at least one metric and at least one additional parameter selected from the group consisting of: first field identity ratio and second field identity ratio of a second subsequent frame.

18. A computer readable medium having embodied thereon a program executable by a machine, the program being operable to perform a sequence of operations on video data, the sequence of operations comprising:
receiving a sequence of video frames in an interlaced format;
detecting a 3-2 pulldown pattern; and
removing duplicate fields from the sequence of video frames.

19. The computer readable medium of claim 18 wherein the sequence of operations further comprises:
passing instructions to a video encoder relating to the removed fields.

20. The computer readable medium of claim 18 wherein the sequence of operations further comprises:
detecting a disrupted 3-2 pulldown pattern at an end of the sequence of video frames; and
leaving a duplicate field that is part of the disrupted 3-2 pulldown pattern.

21. The computer readable medium of claim 18 wherein the operation of detecting a 3-2 pulldown pattern comprises:
identifying a position within a buffer where the 3-2 pulldown pattern is likely to be found; and
determining whether a pattern located at the identified position is a legitimate 3-2 pulldown pattern.

22. A method of processing video data comprising:
receiving a sequence of video frames in an interlaced format and storing the sequence of video frames in a buffer having a plurality of positions, each position in the buffer corresponding to a video frame;
identifying the position within the buffer where the 3-2 pulldown pattern is likely to be found;
determining whether a pattern located at the identified position is a legitimate 3-2 pulldown pattern; and
removing duplicate fields from the sequence of video frames.

23. The method of claim 22 further comprising:
passing instructions to a video encoder relating to the removed fields.

24. The method of claim 22 further comprising:
detecting a disrupted 3-2 pulldown pattern at an end of the sequence of video frames; and
leaving a duplicate field that is part of the disrupted 3-2 pulldown pattern.
